(19) United States
(12) Patent Application Publication
(10) Pub. No.: US 2025/0086023 A1
(43) Pub. Date: Mar. 13, 2025

(54) LOCKLESS SYSTEMS AND METHODS FOR STATEFUL WORKLOAD DISTRIBUTION

(71) Applicant: c/o Microsoft Technology Licensing, LLC, Redmond, WA (US)

(72) Inventors: Ali KANSO, Kirkland, WA (US); Arijit TARAFDAR, Sammamish, WA (US); Sumeet KHUSHALANI, Kenmore, WA (US)

(21) Appl. No.: 18/463,005

(22) Filed: Sep. 7, 2023

(51) Int. Cl. G06F 9/50

(52) U.S. Cl. CPC G06F 9/505; G06F 9/5072

(57) ABSTRACT

Described are examples for distributing stateful workloads to clusters including obtaining, for a cluster, a previous configuration from a shared database, wherein the previous configuration includes a previous indication of a previous owner of a stateful workload, obtaining, for the cluster and from the shared database, a configuration including an indication of a current owner of the stateful workload. Based on determining that the cluster is the current owner, the cluster can continue processing a next state of the stateful workload, which may be based on one or more other considerations.

### BACKGROUND

Cloud-based computing platforms are provided where applications can execute, access storage, control or receive input from devices, etc. over multiple distributed network nodes. The network nodes, which can be virtual machines (VMs) executing on separate devices (e.g., servers) are connected to one another via one or more network connections that may include the Internet. Multiple network nodes can be grouped into clusters for handling processing of workloads, and workloads can be distributed across multiple servers or clusters for processing. Some workloads can include stateful workloads that execute in a flow of multiple states until completion. In some cases, a stateful workload can have different states processed by different clusters. Typically, a locking mechanism, such as a semaphore or mutex, is used to manage using the different clusters to process different states of a stateful workload to ensure that processing of one state is completed before processing of another state begins. The locking mechanism may be implemented using a database record or document. Intensive use of the database to both read and write to examine the lock and renew the lock may lead to inefficiency in using the different clusters to process the stateful workload, which may mitigate benefits of distributing processing of the stateful workload.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, A computer-implemented method for distributing stateful workloads to clusters is provided that includes obtaining, for a cluster, a previous configuration from a shared database, wherein the previous configuration includes a previous indication of a previous owner of a stateful workload, and obtaining, for the cluster and from the shared database, a configuration including an indication of a current owner of the stateful workload. Based on determining that the cluster is the current owner, the method can include determining, based on the indication of the current owner, whether the cluster is the previous owner of the stateful workload. Based on determining that the cluster is the previous owner of the stateful workload, the method can include continuing to process a next state of the stateful workload, and based on determining that the cluster is not the previous owner of the stateful workload, the processing can include waiting for a duration before processing the next state of the stateful workload. Based on determining that the cluster is not the current owner, the method can include refraining from processing the stateful workload.

In another example, a device for distributing stateful workloads to a cluster is provided that includes one or more memories storing instructions, and one or more processors coupled to the one or more memories. The one or more processors are configured to execute the instructions to store, in the one or more memories, a previous configuration received from a shared database, wherein the previous configuration includes a previous indication of a previous owner of a stateful workload, obtain, for the cluster and from the shared database, a configuration including an indication of a current owner of the stateful workload, based on determining that the cluster is the current owner and the previous owner, provide a response to a job handler to process a next state of the stateful workload, based on determining that the cluster is the current owner and not the previous owner, provide a response to a job handler to wait a duration and then process a next state of the stateful workload, and based on determining that the cluster is the not current owner, refrain from processing the stateful workload.

In another example, a non-transitory computer-readable device is provided that stores instructions that, when executed by at least one computing device, cause the at least one computing device to perform operations for distributing stateful workloads to clusters. The operations includes obtaining a previous configuration from a shared database, wherein the previous configuration includes a previous indication of a previous owner of a stateful workload, obtaining, for a cluster and from the shared database, a configuration including an indication of a current owner of the stateful workload, based on determining that the cluster is the current owner and the previous owner, providing a response to a job handler to process a next state of the stateful workload, based on determining that the cluster is the current owner and not the previous owner, providing a response to a job handler to wait a duration and then process a next state of the stateful workload, and based on determining that the cluster is the not current owner, refraining from processing the stateful workload. To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a system for performing functions related to performing lockless distribution of stateful workload processing, in accordance with aspects described herein.

FIG. 2 is a schematic diagram of an example of a system with multiple clusters for executing stateful workloads, in accordance with aspects described herein.

FIG. 3 is a flow diagram of an example of a method for determining ownership for processing a state of a stateful workload, in accordance with aspects described herein.

FIG. 4 illustrates an example of a process 400 for determining whether to process a stateful workload, in accordance with aspects described herein.

FIG. 5 is a flow diagram of an example of a method for reporting health information for one or more components of a cluster, in accordance with aspects described herein.

FIG. 6 illustrates an example of a call flow among various components for refraining from processing a workload where the cluster is not the owner, in accordance with aspects described herein.

FIG. 7 illustrates an example of a call flow among various components for processing a workload where the cluster is the owner but not the previous owner, in accordance with aspects described herein.

FIG. 8 illustrates an example of a call flow among various components for processing a workload where the cluster is the owner but not the previous owner and the previous owner has not acknowledged the change in ownership, in accordance with aspects described herein.

FIG. 9 illustrates an example of a call flow among various components for reporting unhealthy status when cache is not up to date, in accordance with aspects described herein.

FIG. 10 illustrates an example of a call flow among various components for killing a process based on reporting unhealthy status, in accordance with aspects described herein.

FIG. 11 is a flow diagram of an example of a method for modifying a set of clusters, in accordance with aspects described herein.

FIG. 12 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to lockless distributing of processing of states of a stateful workload. For example, stateful workloads can be workloads defined as a flow of multiple states that can be executed until completion. A cluster can execute one or more states of a stateful workload. A cluster can include a collection of physical resources, such as a collection of multiple servers, network nodes, etc., providing processing resources to process workloads. An example of a stateful workload, which can also be referred to as a job, can be training a machine learning model. Such a stateful workload can include the states of: (1) create a set of machines (e.g., virtual machines (VMs)) with processing units (e.g., graphical processing units (GPUs)) to train the model; (2) load the dataset into the set of machines; (3) start the training; (4) save the trained model into a model repository; and (5) set permissions and create access control. A software process for executing the states of a stateful workload, updating the state of the job in persistent storage, and moving on to the next step, can be defined as a job handler.

A job handler can be provided by a cluster, where the stateful workloads can be distributed across clusters. While the stateful workload is processing, clusters can be added, removed, or otherwise modified, which may cause a job originally assigned to a certain cluster (e.g., cluster-A) to be reassigned to another cluster (e.g., cluster-B). To guarantee that the job handler in cluster-B does not replicate a step that the job handler in cluster-A is already performing, conventional systems use a locking mechanism, such as a semaphore or mutex. For a cross-cluster synchronization, a more global approach like a shared database where a state of the job can be stored as a database record or document, can be used. A job handler can lock the database record while working on a job, and if the job handler is no longer the handler of the job, it can complete the current step, update the state without renewing the lock. When the lock expires a different job handler can pick up the job and carry on the next step. A major limitation of this approach can be intensive use of the database in both read and write to examine the lock and renew the lock.

Accordingly, aspects described herein include storing a cluster configuration in the database. Upon a configuration change, a difference between the current version of the configuration and the previous version before the configuration change is made can be examined to determine if a given job is impacted, and processing of the stateful workload can accordingly proceed. While making a DB call can take 10's or 100's of milliseconds, including the network delays, hashing functions have O(n) time complexity, completing in the order of microseconds. Hence by replacing database calls for locking with local hashing computation, performance of distributing processing stateful workloads can be improved at an exponential scale.

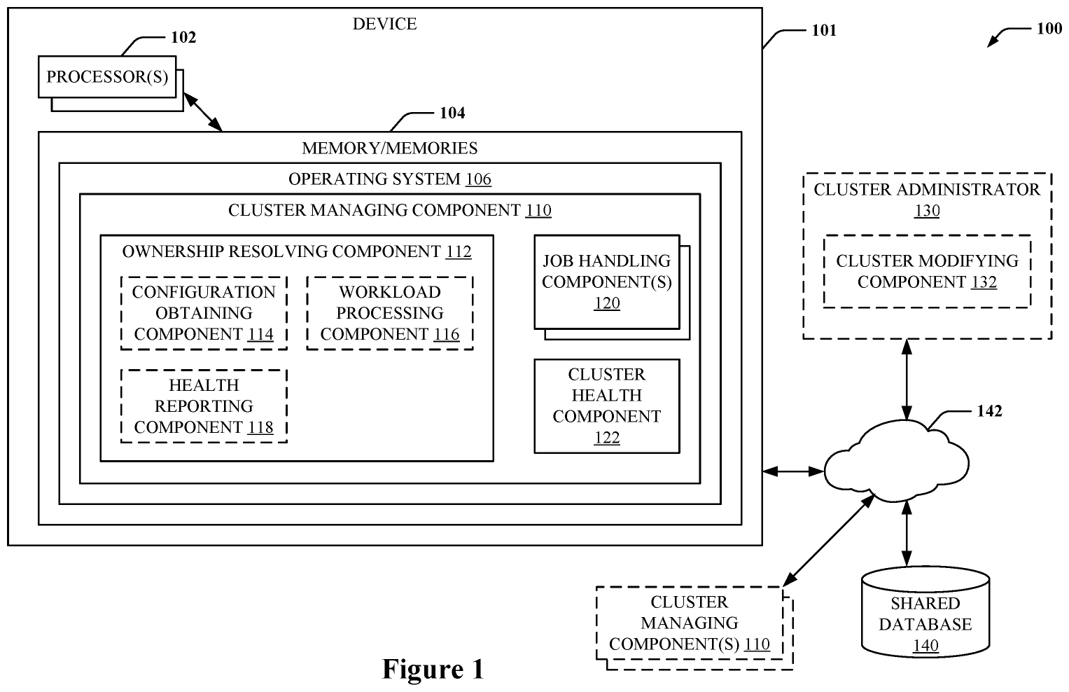

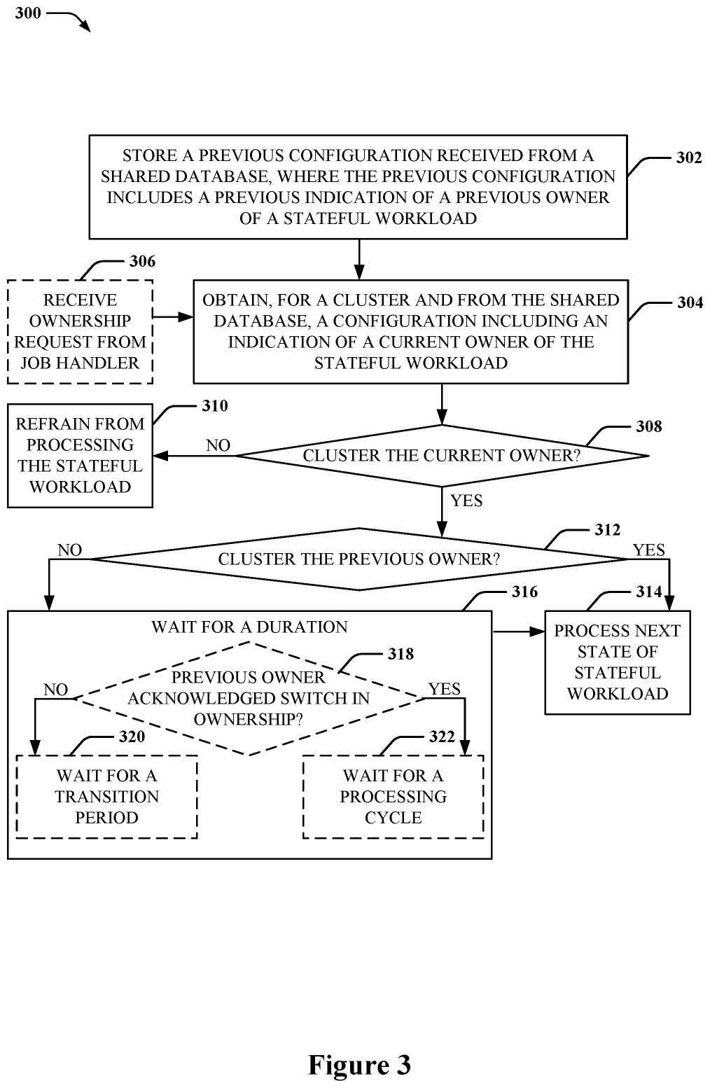

Turning now to FIGS. 1-12, examples are depicted with reference to one or more components and one or more methods that may perform the actions or operations described herein, where components and/or actions/operations in dashed line may be optional. Although the operations described below in FIG. 3 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X. Y. and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X. Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X. Y, or Z, and the three processor may in combination execute the respective subset of instruction to accomplish performing actions X. Y, and Z. Alternatively, a single processor may execute the instructions stored on a single memory, or distributed across multiple memories, to accomplish performing actions X, Y, and Z.

FIG. 1 is a schematic diagram of an example of a system 100 for performing functions related to performing lockless distribution of stateful workload processing, in accordance with aspects described herein. In an example, system 100 can include a device 101 that can include one or more processors 102 and/or memory/memories 104 configured to execute or store instructions or other parameters related to providing an operating system 106, which can execute one or more applications or processes. For example, processor(s) 102 and memory/memories 104 may be separate components communicatively coupled by a bus (e.g., on a motherboard or other portion of a computing device, on an integrated circuit, such as a system on a chip (SoC), etc.), components integrated within one another (e.g., processor(s) 102 can include the memory/memories 104 as an on-board component), and/or the like. Memory/memories 104 may store instructions, parameters, data structures, etc. for use/execution by processor(s) 102 to perform functions described herein. In another example, processor(s) 102 and/or memory/memories 104 can be distributed over multiple devices or physical computing nodes in a network (e.g., in a cloud-based computing platform) for providing the functions of the various components described herein.

In one example, the device 101 can include one or more physical devices (e.g., servers) that provide a cluster for processing workloads. In an example, the operating system 106 can execute one or more applications or processes, such as, but not limited to, a cluster managing component 110 for managing a cluster to provide processing resources for workloads. The cluster managing component 110 can include an ownership resolving component 112 for resolving ownership of a stateful workload as belonging to a cluster, such as the cluster managed by cluster managing component 110 or a different cluster. In an example, ownership resolving component 112 can manage distribution of processing for a stateful workload to one or more job handling components 120, which can each correspond to a job handler. As described, a job handler can correspond to a processing resource on one or more physical machines (e.g., servers), virtual machines (VMs), and/or the like, such that the ownership resolving component 112 can provide instructions to the job handler (e.g., via an associated job handling component 120) to cause the job handler to execute a corresponding process (e.g., a state of a stateful workload).

In an example, the cluster managing component 110 can also include a cluster health component 122 for obtaining information regarding health of the cluster, one or more associated job handling component 120 or job handlers, and/or ownership resolving component 112. In an example, the ownership resolving component 112 can include a configuration obtaining component 114 for obtaining a configuration indicating an owner of a stateful workload, a workload processing component 116 for causing a job handling component 120 to execute a state of a stateful workload where the cluster managed by cluster managing component 110 is a current owner of the stateful workload, and/or a health reporting component 118 for reporting health information of the ownership resolving component 112 and/or one or more job handling components 120 or associated job handlers.

In addition, system 100 can include additional cluster managing components 110 operating on other devices to provide additional clusters. System 100 can also include a cluster administrator 130, which can also operate on another device, to distribute a stateful workload among multiple clusters, add clusters, remove clusters, modify clusters, etc. The other devices are not shown for case of explanation, but can also include processor(s), memory/memories, operating systems, etc., to provide corresponding functionality described herein. In an example, cluster administrator 130 can include a cluster modifying component 132 for modifying a collection of clusters, which may be based on adding, removing, or modifying one or more of a collection of clusters available for processing workloads. System 100 may also include a shared database 140 for storing ownership information for a stateful workload, which can be modified by the cluster modifying component 132 and/or accessed by ownership resolving component(s) 112 of one or more cluster managing components 110 for one or more clusters to obtain the ownership information. The various devices 101, associated components 110, 132, shared database 140, etc. can communicate over a network 142. In some examples, various portions of the components 110, 132 (or associated sub-components, portions thereof, etc.) can be provided on one or multiple physical resources (e.g., servers) distributed throughout network 142.

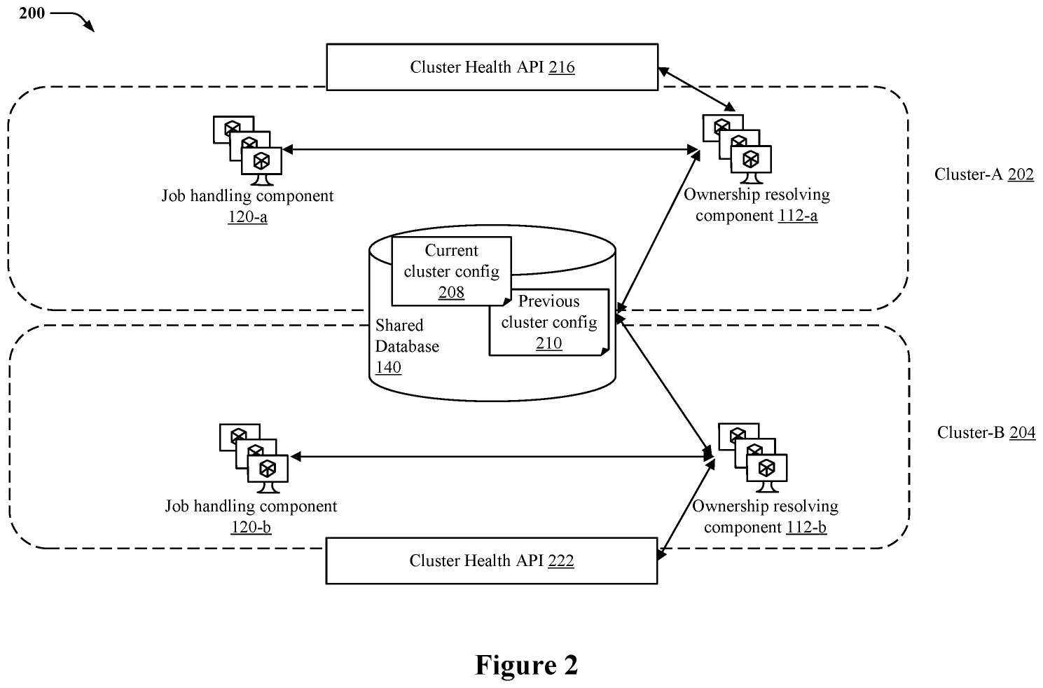

FIG. 2 is a schematic diagram of an example of a system 200 with multiple clusters for executing stateful workloads, in accordance with aspects described herein. System 200 can include cluster-A 202 and cluster-B 204, which can be managed by respective cluster managing components 110 on one or more devices 101, as described herein. In addition, system 200 includes the shared database 140, which provides various cluster configurations, including a current cluster configuration 208 and one or more previous cluster configurations 210. Cluster-A can include an ownership resolving component 112-a and one or more job handling components 120-a (or associated job handlers). Cluster-A 202 can also include a cluster health application programming interface (API) 216, which can be similar to cluster health component 122. Cluster-B 204 can similarly include an ownership resolving component 112-b, one or more job handling components 120 (or associated job handlers), and a cluster health API 222. In an example, the clusters 202 and 204 may be assumed to be using a timing protocol to synchronize clocks.

In an example, the ownership resolving components 112-a and 112-b can each expose an API that can be called to determine to which cluster a stateful workload belongs. In an example, the ownership resolving components 112-a and 112-b can use consistent hashing to determine an owner of the stateful workload. For example, the ownership resolving components 112-a and 112-b can use consistent hashing based on a workspace identifier associated with the stateful workload (e.g., as indicated in a hypertext transfer protocol (HTTP) request path of the stateful workload) and an attribute value of the cluster (e.g., a cluster identifier) to determine to which cluster the stateful workload is assigned (or to determine whether the stateful workload is assigned to the current cluster). The ownership resolving components 112-a and 112-b can be notified each time the cluster configuration changes in the shared database 140. A change in cluster configuration may result in change of attribute value of the cluster, which may result in change in ownership for a stateful workload (e.g., based on the consistent hashing with the cluster attributes or other load balancing procedures). In an example, the ownership resolving components 112-a and 112-b can periodically (e.g., every 1 processing cycle) fetch the cluster configuration from the shared database 140 just in case a notification of cluster modification was not delivered.

For example, both the ownership resolving components 112-a and 112-b and the job handling components 120-a and 120-b can be expected to periodically send health information (e.g., heartbeat messages) to the cluster health component 122 (e.g., via corresponding cluster health API 216 or 222) to report the health information. As a safety mechanism, when the ownership resolving component 112-a or 112-b fail to contact the shared database 140 for a threshold of consecutive attempts, the ownership resolving component 112-a or 112-b can declare itself unhealthy, or send corresponding health information, using the corresponding cluster health API 216 or 222. In addition, in this example, the ownership resolving component 112-a or 112-b can reply to ownership requests indicating unknown ownership status, which can cause a job handling component 120-a or 120-b to refrain from processing the stateful workload. In another example, the ownership resolving component 112-a or 112-b or the job handling component 120-a or 120-b may endure a type of failure causing it to freeze (e.g., the CPU utilization may be at full capacity, causing the process to halt its execution). In this example, the frozen process may cause the ownership resolving component 112-a or 112-b or the job handling component 120-a or 120-b to fail to notify the cluster health component 122 with its status. After missing a certain number of heartbeats, the cluster health component 122 can kill the faulty process causing it to be restarted.

In an example, the job handling components 120-a and 120-b can ensure that stateful workloads are processed until completion. The job handling components 120-a and 120-b can consult with their respective ownership resolving component 112-a or 112-b after each processing step, which takes the stateful workload to the next state, and this process can be repeated until the stateful workload reaches its terminal state. The job handling components 120-a and 120-b can also be asked to halt execution for a particular stateful workload for a certain period of time if this job is suspected to being processed in parallel by another job handler in another cluster. In another example, the shared database 140 can maintain both the current cluster configuration 208 and one or more previous cluster configurations 210. In an example, the shared database 140 can enforce a constraint that the cluster-configuration cannot be updated twice within a transition period, as described further herein. Any ownership resolver from any cluster can access the database and fetch the configuration documents.

For example, the cluster configurations 208 and 210 can include a timestamp of a last impactful change, a list of clusters, etc. The list of clusters may include, for each cluster, a cluster name, port for communicating with the cluster, a host address of the cluster (e.g., of a device 101 that manages the cluster), a scheme for accessing the cluster (e.g., HTTP), a weight for load balancing processes to the cluster, and/or a time (e.g., timestamp) at which the cluster signed or approved a modified cluster configuration.

FIG. 3 is a flowchart of an example of a method 300 for determining ownership for processing a state of a stateful workload, in accordance with aspects described herein. For example, method 300 can be performed by a device 101 and/or one or more components thereof, such as a cluster managing component 110, ownership resolving component 112, etc., to facilitate determining ownership of a stateful workload for processing one or more states thereof.

In method 300, at action 302, a previous configuration received from a shared database can be stored, where the previous configuration includes a previous indication of a previous owner of a stateful workload. In an example, configuration obtaining component 114, e.g., in conjunction with processor(s) 102, memory/memories 104, operating system 106, cluster managing component 110, ownership resolving component 112, etc., can store (e.g., in memory/memories 104) the previous configuration (e.g., previous cluster configuration 210) received from the shared database (e.g., shared database 140), where the previous configuration includes a previous indication of the previous owner of the stateful workload. For example, configuration obtaining component 114 can obtain the previous configuration as part of a previous process performed to determine whether the cluster managed by cluster managing component 110 is the owner of the stateful workload (e.g., as described in action 304 below). In an example, the previous configuration can identify the owner or can include one or more parameters used for determining the owner, such as a cluster attribute, etc. In an example, configuration obtaining component 114 can store the previous configuration for use in determining whether and/or when to process a state of the stateful workload, as described herein.

In method 300, at action 304, a configuration indicating an indication of a current owner of the stateful workload can be obtained for a cluster and from the shared database 140. In an example, configuration obtaining component 114, e.g., in conjunction with processor(s) 102, memory/memories 104, operating system 106, cluster managing component 110, ownership resolving component 112, etc., can obtain, for the cluster (e.g., the cluster managed by cluster managing component 110) and from the shared database (e.g., shared database 140), the configuration (e.g., current cluster configuration 208) including the indication of the current owner of the stateful workload. For example, the configuration may include an indication of the current owner or one or more parameters for determining the current owner using consistent hashing (e.g., a cluster attribute that can be used with a workspace identifier to determine which cluster is the current owner).

In method 300, optionally at action 306, an ownership request can be received from a job handler. In an example, configuration obtaining component 114, e.g., in conjunction with processor(s) 102, memory/memories 104, operating system 106, cluster managing component 110, ownership resolving component 112, etc., can receive the ownership request from the job handler (e.g., one or more job handling components 120 in the cluster managed by cluster managing component 110). For example, a job handling component 120 can request ownership information for the stateful workload to determine whether the job handling component 120 is to process a state of the stateful workload. In one example, job handling component 120 can request ownership information after completing processing of a state of the stateful workload. As described, the ownership resolving component 112 can provide an API that the job handling component 120 can call to resolve ownership for the stateful workload.

In an example, configuration obtaining component 114 can obtain the current cluster configuration from the shared database 140 based on the request from the job handling component 120. In another example, configuration obtaining component 114 can additionally or alternatively periodically obtain the current cluster configuration from the shared database 140, as described herein.

In method 300, at action 308, it can be determine whether the cluster is the current owner of the stateful workload. In an example, ownership resolving component 112. e.g., in conjunction with processor(s) 102, memory/memories 104, operating system 106, cluster managing component 110, etc., can determine whether the cluster (e.g., the cluster managed by cluster managing component 110) is the current owner of the stateful workload. For example, ownership resolving component 112 can determine whether the cluster is the current owner based at least in part on the current cluster configuration obtained by the configuration obtaining component 114 (e.g., at action 304). In an example, ownership resolving component 112 can use consistent hashing based at least in part on an attribute value of the cluster indicated in the current cluster configuration and/or a property of the workspace (e.g., workspace identifier) to determine whether the cluster is the current owner of the stateful workload.

For example, a workload or a job can be bounded to a workspace, as described. A workspace can be determined to be owned by a cluster. One example for determining this ownership based on consistent hashing can include grouping or concatenating <workspace-id+cluster-ID> for each of the clusters and hashing that value. The cluster whose hash has the highest value can be determined as the owner. In this example, an impactful change, as described herein, can be one where clusters are added or removed in the configuration, which can change the cluster owning a particular workspace. Another attribute in the configuration can include a cluster weight, where certain clusters are assigned higher weights that others, and the hashed value can be multiplied by the weight to determine the owner, giving the cluster with the higher weight a higher probability of owning more workspaces. Therefore changing the weight can change the ownership result. In this example, an impactful change to the configuration, as described herein, can also include modifying the weight assigned to one or more clusters.

If it is determined, at action 308, that the cluster is not the current owner, method 300 can include, at action 310, refraining from processing the stateful workload. In an example, workload processing component 116, e.g., in conjunction with processor(s) 102, memory/memories 104, operating system 106, cluster managing component 110, ownership resolving component 112, etc., can refrain from processing the stateful workload (e.g., using one or more job handling components 120) based on determining that the cluster is not the current owner of the stateful workload.

If it is determined, at action 310, that the cluster is the current owner, method 300 can include, at action 312, determining whether the cluster is the previous owner of the stateful workload. In an example, ownership resolving component 112, e.g., in conjunction with processor(s) 102, memory/memories 104, operating system 106, cluster managing component 110, etc., can determine whether the cluster (e.g., the cluster managed by the cluster managing component 110) is the previous owner of the stateful workload, which may be based on the previous configuration, as described.

If it is determined, at action 312, that the cluster is the previous owner, method 300 can include, at action 314, processing a next state of the stateful workload. In an example, workload processing component 116, e.g., in conjunction with processor(s) 102, memory/memories 104, operating system 106, cluster managing component 110, ownership resolving component 112, etc., can process the next state of the stateful workload. For example, as the cluster was the previous owner and is the current owner, the cluster can continue processing the next state of the stateful workload without having to wait for transition from a previous cluster (e.g., process completion by the previous cluster, storing of state information by the previous cluster, etc.).

If it is determined, at action 312, that the cluster is not the previous owner, method 300 can include, at action 316, waiting for a duration. In an example, workload processing component 116. e.g., in conjunction with processor(s) 102, memory/memories 104, operating system 106, cluster managing component 110, ownership resolving component 112, etc., can wait for the duration before processing the next state of the stateful workload. For example, the duration can sufficient for allowing the previous owner to complete processing of the state, store any state information to be used in processing the next state, etc. Once the duration is over, method 300 can proceed to action 314 to process the next state of the stateful workload (e.g., by workload processing component 116, as described above).

In waiting for the duration at action 316, different durations can be determined based on whether the previous owner acknowledged the switch in ownership. For example, at action 318, it can be determined whether the previous owner acknowledged the switch in ownership from the previous cluster to the current cluster. In an example, workload processing component 116, e.g., in conjunction with processor(s) 102, memory/memories 104, operating system 106, cluster managing component 110, ownership resolving component 112, etc., can determine whether the previous owner acknowledged the switch in ownership. In an example, this can be based on whether the previous owner signed or acknowledged the change in cluster configuration, from which the change in ownership can be determined. For example, workload processing component 116 can determine whether the previous owner acknowledged the switch based on information in the current cluster configuration, such as a timestamp at which the cluster that is the previous owner signed the current cluster configuration.

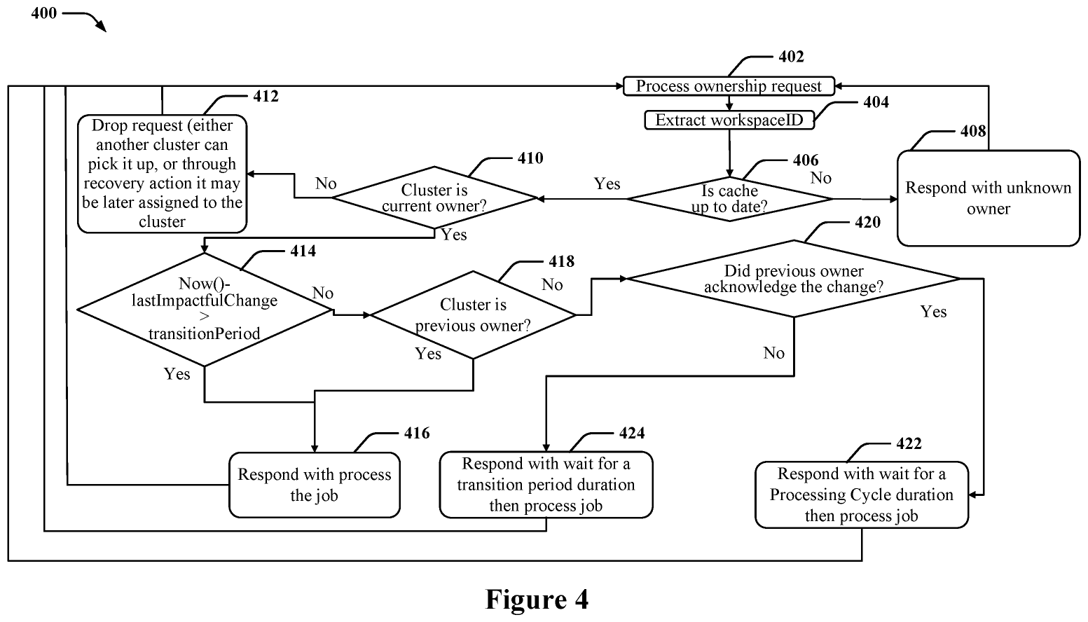

If the previous owner did not acknowledge the switch, waiting for the duration at action 316 can include, at action 320, waiting for a transition period. If the previous owner acknowledged the switch, waiting for the duration at action 316 can include, at action 322, waiting for a processing cycle. For example, the transition period can be longer than the processing cycle (and/or can be a multiple of processing cycles). As described, the transition period can allow the previous owner to complete processing and/or save state information. The processing cycle can ensure the previous owner completed the processing cycle during which it may have acknowledged the switch before the current cluster takes over processing the next state. A specific example is shown in FIG. 4.

FIG. 4 illustrates an example of a process 400 for determining whether to process a stateful workload, in accordance with aspects described herein. For example, process 400 can be performed by a cluster managing component 110 or one or more components thereof, as described herein. At 402, an ownership request can be processed. For example, the ownership request can be received from one or more job handlers for determining ownership of a stateful workload, also referred to herein as a job. Based on processing the ownership request at 402, at 404, a workspace identifier for the job can be extracted. At 406, it can be determined whether cache is up to date, e.g., whether the cluster configuration cache stored by the ownership resolving component 112 is up to date. In one example, this can be determined based on comparing a timestamp of the current cluster configuration at the ownership resolving component 112 to a current time, to a time of a last impactful change to the configuration, etc. For example, an impactful change can include a change to the configuration that results in addition or removal of clusters in the configuration, or modification of a weight assigned to one or more of the clusters in the configuration. If the cache is not up to date at 406, at 408, the ownership request can be responded to with “unknown owner.” If the cache is up to date at 406, at 410, it can be determined whether the subject cluster is the desired owner of the stateful workload (e.g., as indicated by or determined based on the current cluster configuration).

If the subject cluster is not the desired owner at 410, at 412, the ownership request can be dropped and either another cluster can pick it up for processor, or through a recovery action, it may be later assigned to the subject cluster. If the subject cluster is the desired owner at 410, at 414, it can be determined whether a time associated with a last impactful change to the configuration subtracted from the current time is greater than a transition period value. The transition period value can be defined as a fixed duration that should be long enough for a job handler to complete handling the job and store any state information to be used for processing the next stage of the job. If the time associated with the last impactful change to the configuration subtracted from the current time is greater than the transition period value at 414, at 416, the ownership request can be responded to with “process the job” or similar command or notification. If the time associated with the last impactful change to the configuration subtracted from the current time is not greater than the transition period value at 414, at 418, it can be determined whether the subject cluster is also the previous owner of the job.

If the subject cluster is the previous owner of the job at 418, at 416, the ownership request can be responded to with “process the job” or similar command or notification. If the subject cluster is not the previous owner of the job at 418, at 420, it can be determined whether the previous owner acknowledged the change in ownership. As described, for example, this can be based on a timestamp of the previous owner in the current cluster configuration (e.g., comparing the timestamp of the previous owner to a timestamp of the last impactful change). If the previous owner acknowledged the change at 420, at 422, the ownership request can be responded to with “wait for a processing cycle duration then process the job” or similar command or notification. If the previous owner did not acknowledge the change at 420, at 424, the ownership request can be responded to with “wait for a transition period duration then process the job” or similar command or notification.

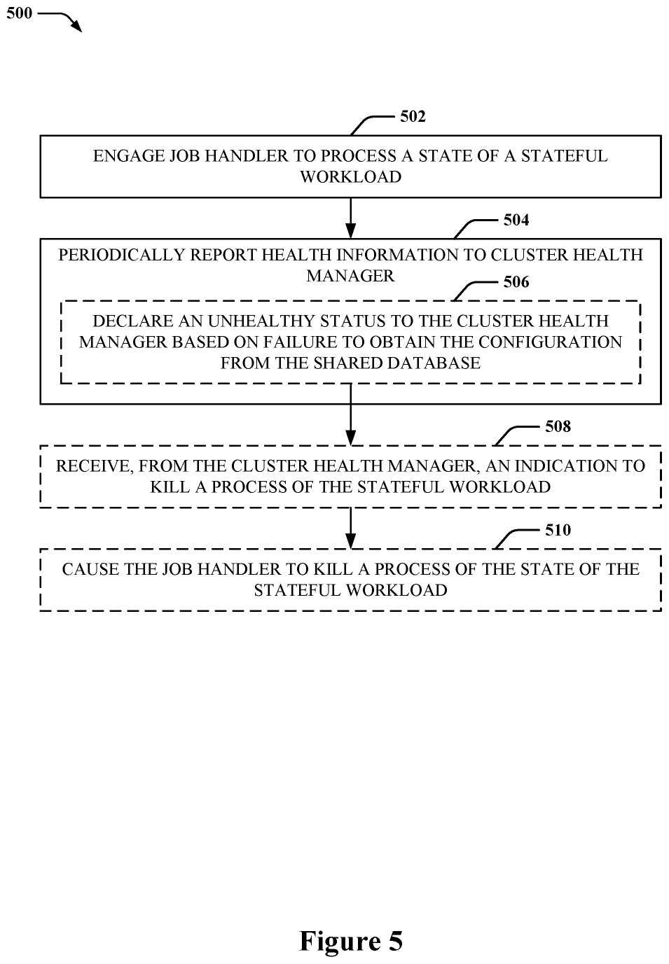

FIG. 5 is a flowchart of an example of a method 500 for reporting health information for one or more components of a cluster, in accordance with aspects described herein. For example, method 500 can be performed by a device 101 and/or one or more components thereof, such as a cluster managing component 110, ownership resolving component 112, etc., to facilitate reporting the health information.

In method 500, at action 502, a job handler can be engaged to process a state of a stateful workload. In an example, workload processing component 116, e.g., in conjunction with processor(s) 102, memory/memories 104, operating system 106, cluster managing component 110, ownership resolving component 112, etc., can engage the job handler (e.g., via a job handling component 120) to process the state of the stateful workload. For example, this can be in response to an ownership request from the job handling component 120 indicating to proceed to process the stateful workload. In an example, workload processing component 116 can cause the job handling component 120, or associated job handler, to process the state of the stateful workload based on the ownership resolving component 112 determining that the cluster managed by the cluster managing component 110 is the current owner of the stateful workload (e.g., as described in conjunction with action 314, or at 416, 422, or 424).

In method 500, at action 504, health information can be periodically reported to a cluster health manager. In an example, health reporting component 118, e.g., in conjunction with processor(s) 102, memory/memories 104, operating system 106, cluster managing component 110, ownership resolving component 112, etc., can periodically report (e.g. via a cluster health API 216 or 222) health information to the cluster health manager (e.g., to cluster health component 122). For example, health reporting component 118 can report the health information to the cluster health manager while the job handler is processing the stateful workload or otherwise. The health information can correspond to the ownership resolving component 112 and/or one or more job handling components 120 or associated job handlers. For example, the health information can include a periodic indication that the ownership resolving component 112 can communicate with the shared database 140 and/or other components, a periodic heartbeat or status indicating that there are no errors, etc.

In periodically reporting the health information at action 504, optionally, at action 506, an unhealthy status can be declared to the cluster health manager based on failure to obtain the configuration from the shared database 140. In an example, health reporting component 118, e.g., in conjunction with processor(s) 102, memory/memories 104, operating system 106, cluster managing component 110, ownership resolving component 112, etc., can declare the unhealthy status to the cluster health manager based on failure to obtain the current cluster configuration from the shared database 140. In another example, health reporting component 118 can declare, to the cluster health manager, an unhealthy status of one or more of the job handling components 120 (e.g., where periodic health information or heartbeats are not received from the one or more job handling components 120).

In method 500, optionally at action 508, an indication to kill a process of the stateful workload can be received from the cluster health manager. In an example, health reporting component 118, e.g., in conjunction with processor(s) 102, memory/memories 104, operating system 106, cluster managing component 110, ownership resolving component 112, etc., can receive, from the cluster health manager (e.g., from cluster health component 122), the indication to kill the process of the stateful workload. For example, cluster health component 122 can provide the indication to the ownership resolving component 112 based at least in part on receiving the unhealthy status of the ownership resolving component 112 or one or more job handling components 120.

In method 500, optionally at action 510, the job handler can be caused to kill a process of the state of the stateful workload. In an example, workload processing component 116, e.g., in conjunction with processor(s) 102, memory/memories 104, operating system 106, cluster managing component 110, ownership resolving component 112, etc., can cause the job hander (e.g., job handling component 120) to kill the process of the state of the stateful workload based on receiving the indication from the cluster health component 122 to kill the process. Various examples are shown and described herein.

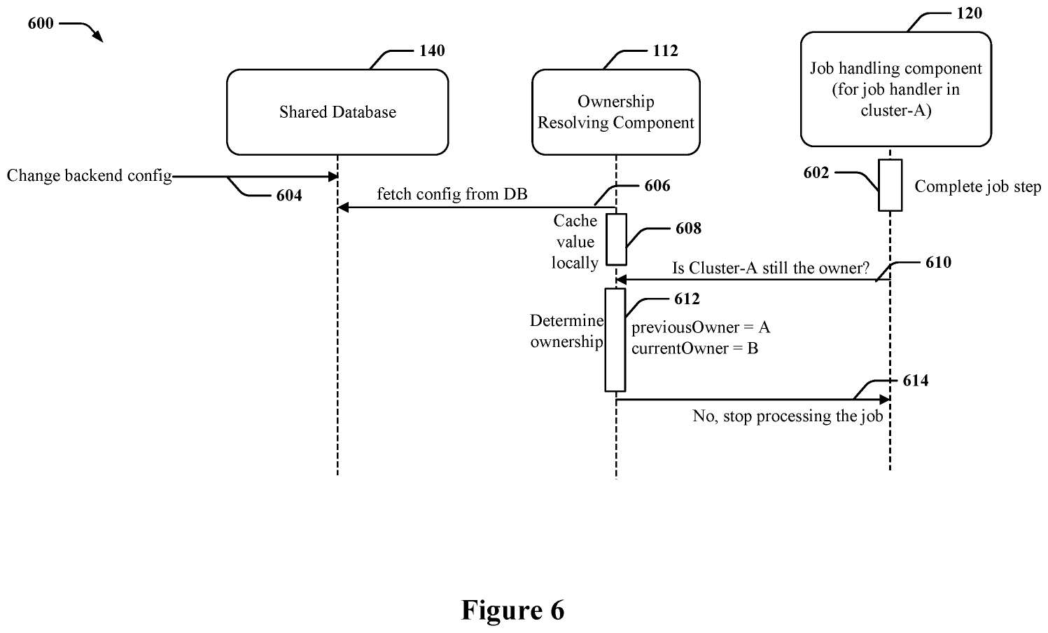

FIG. 6 illustrates an example of a call flow 600 among various components for refraining from processing a workload where the cluster is not the owner, in accordance with aspects described herein. In call flow 600, a job handling component 120 for a job handler in cluster A can complete job step (e.g., a state of the stateful workflow) at 602. At 604, during the job, the shared database 140 can receive a command to change a backend configuration. For example, a cluster modifying component 132 of a cluster administrator 130 can change the backend cluster configuration in the shared database 140 based on modifying a collection of clusters (e.g., such to add, remove, or modify the clusters, a workload the clusters can handle, etc.). In an example, ownership resolving component 112 can fetch the current cluster configuration from the shared database at 606, which may occur periodically and/or in response to completion of the job step at 602. At 608, ownership resolving component 112 can locally cache the current cluster configuration or certain values in the configuration or derived from the configuration, such as which workspaces are owned by the cluster.

At 610, job handling component 120 can provide an ownership request to the ownership resolving component 112 to determine whether the cluster A is still the owner of the stateful workload, which can be sent based on completion of the job step at 602. Ownership resolving component 112 can accordingly determine the ownership at 612 as cluster A being the previous owner, but a different cluster B being the current owner. Based on this determination, ownership resolving component 112 can transmit a command or notification to the job handling component 120 to refrain from processing the job at 614.

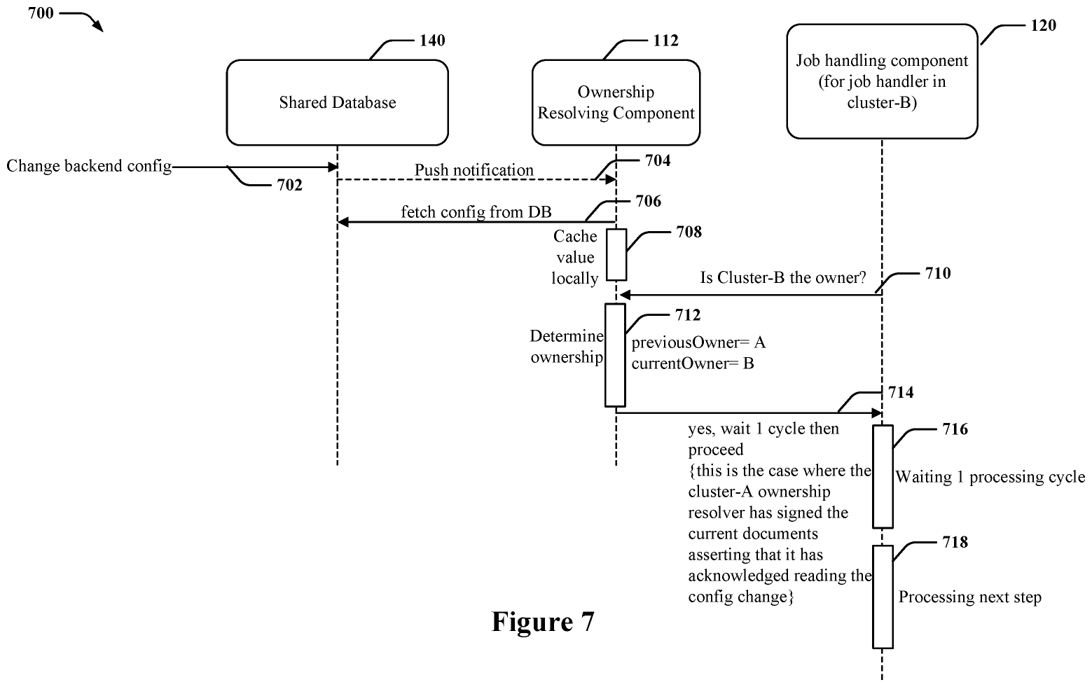

FIG. 7 illustrates an example of a call flow 700 among various components for processing a workload where the cluster is the owner but not the previous owner, in accordance with aspects described herein. In call flow 700, at 702, the shared database 140 can receive a command to change a backend configuration. For example, a cluster modifying component 132 of a cluster administrator 130 can change the backend cluster configuration in the shared database 140 based on modifying a collection of clusters (e.g., such to add, remove, or modify the clusters, a workload the clusters can handle, etc.). In an example, ownership resolving component 112 can optionally receive a push notification change from the shared database at 704, and/or at 706, can fetch the current cluster configuration from the shared database 140. At 708, ownership resolving component 112 can locally cache the current cluster configuration or certain values in the configuration or derived from the configuration, such as which workspaces are owned by the cluster.

At 710, job handling component 120 can provide an ownership request to the ownership resolving component 112 to determine whether the cluster B is the new owner of the stateful workload. Ownership resolving component 112 can accordingly determine the ownership at 712 as cluster A being the previous owner, and cluster B being the current owner. Based on this determination, ownership resolving component 112 can transmit a command or notification to the job handling component 120 to wait one processing cycle then proceed with processing a next state (or step) of the stateful workflow at 714. As described above, this can be based on cluster-A ownership resolving component acknowledging the change in ownership, which can include signing current documents asserting that it has knowledge regarding the configuration change. Accordingly, at 716, the job handling component 120 can wait one processing cycle, and at 718, can then process the next step.

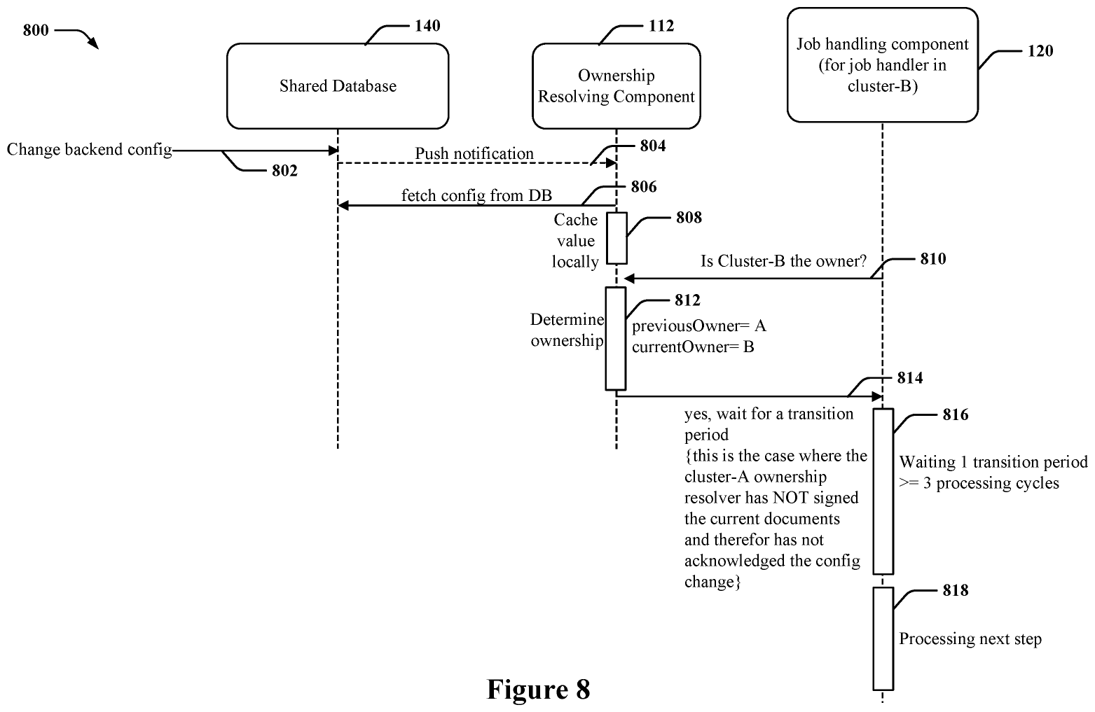

FIG. 8 illustrates an example of a call flow 800 among various components for processing a workload where the cluster is the owner but not the previous owner and the previous owner has not acknowledged the change in ownership, in accordance with aspects described herein. In call flow 800, at 802, the shared database 140 can receive a command to change a backend configuration. For example, a cluster modifying component 132 of a cluster administrator 130 can change the backend cluster configuration in the shared database 140 based on modifying a collection of clusters (e.g., such to add, remove, or modify the clusters, a workload the clusters can handle, etc.). In an example, ownership resolving component 112 can optionally receive a push notification change from the shared database at 804, and/or at 806, can fetch the current cluster configuration from the shared database 140. At 808, ownership resolving component 112 can locally cache the current cluster configuration or certain values in the configuration or derived from the configuration, such as which workspaces are owned by the cluster.

At 810, job handling component 120 can provide an ownership request to the ownership resolving component 112 to determine whether the cluster B is the new owner of the stateful workload. Ownership resolving component 112 can accordingly determine the ownership at 812 as cluster A being the previous owner, and cluster B being the current owner. Based on this determination, ownership resolving component 112 can transmit a command or notification to the job handling component 120 to wait for a transition period then proceed with processing a next state (or step) of the stateful workflow at 814. As described above, this can be based on cluster-A ownership resolving component not acknowledging the change in ownership, which can include cluster A not having signed current documents asserting that it has knowledge regarding the configuration change. Accordingly, at 816, the job handling component 120 can wait one transition period, which can be longer than one processing cycle, and at 818, can then process the next step.

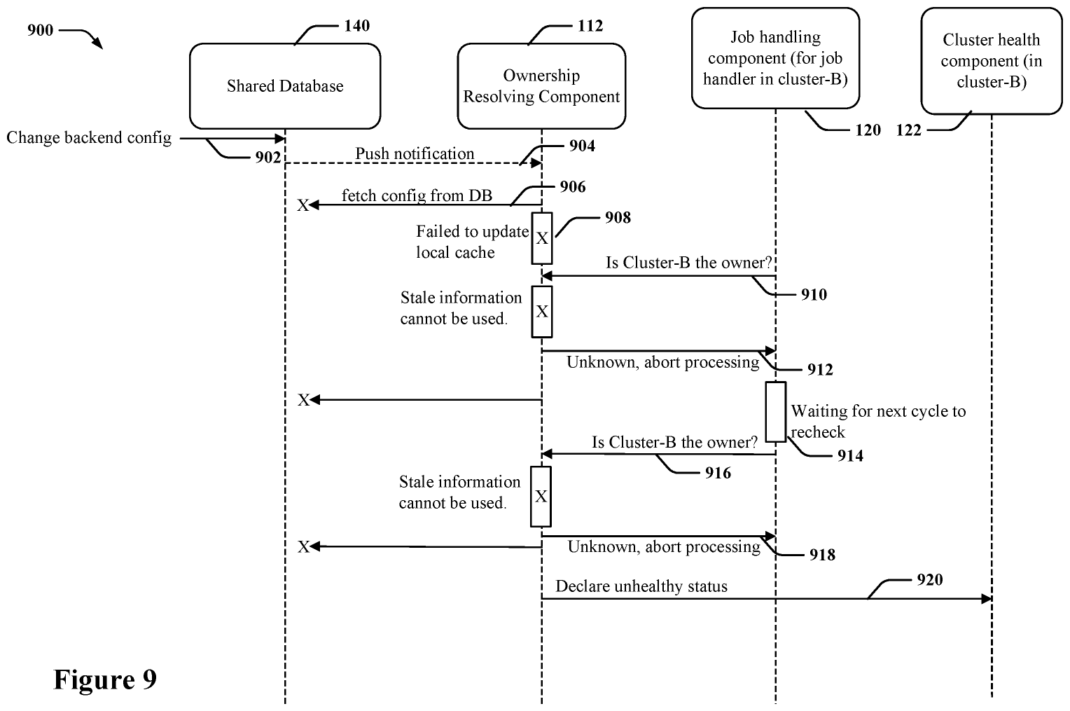

FIG. 9 illustrates an example of a call flow 900 among various components for reporting unhealthy status when cache is not up to date, in accordance with aspects described herein. In call flow 900, at 902, the shared database 140 can receive a command to change a backend configuration. For example, a cluster modifying component 132 of a cluster administrator 130 can change the backend cluster configuration in the shared database 140 based on modifying a collection of clusters (e.g., such to add, remove, or modify the clusters, a workload the clusters can handle, etc.). In an example, ownership resolving component 112 can optionally receive a push notification change from the shared database at 904, and/or at 906, can attempt to fetch the current cluster configuration from the shared database 140. At 908, ownership resolving component 112 can determine that it failed to update the local cache with a cluster configuration from the shared database 140.

At 910, job handling component 120 can provide an ownership request to the ownership resolving component 112 to determine whether the cluster B is the owner of the stateful workload. As stale information cannot be used, at 912, ownership resolving component 112 can send an unknown ownership status and/or abort processing message to the job handling component 120. At 914, the job handling component 120 can wait for a next cycle and can recheck ownership by sending another request to the ownership resolving component 112 at 916. As stale information cannot be used, at 918, ownership resolving component 112 can send an unknown ownership status and/or abort processing message to the job handling component 120. As shown, ownership resolving component 112 can repeatedly attempt to fetch the configuration from the shared database 140 and can fail. After a number of attempts (e.g., 3 attempts, in the depicted example), ownership resolving component 112 can declare an unhealthy status to the cluster health component 122 at 920. This may cause a cluster administrator to assign the workload to a different cluster, in some examples.

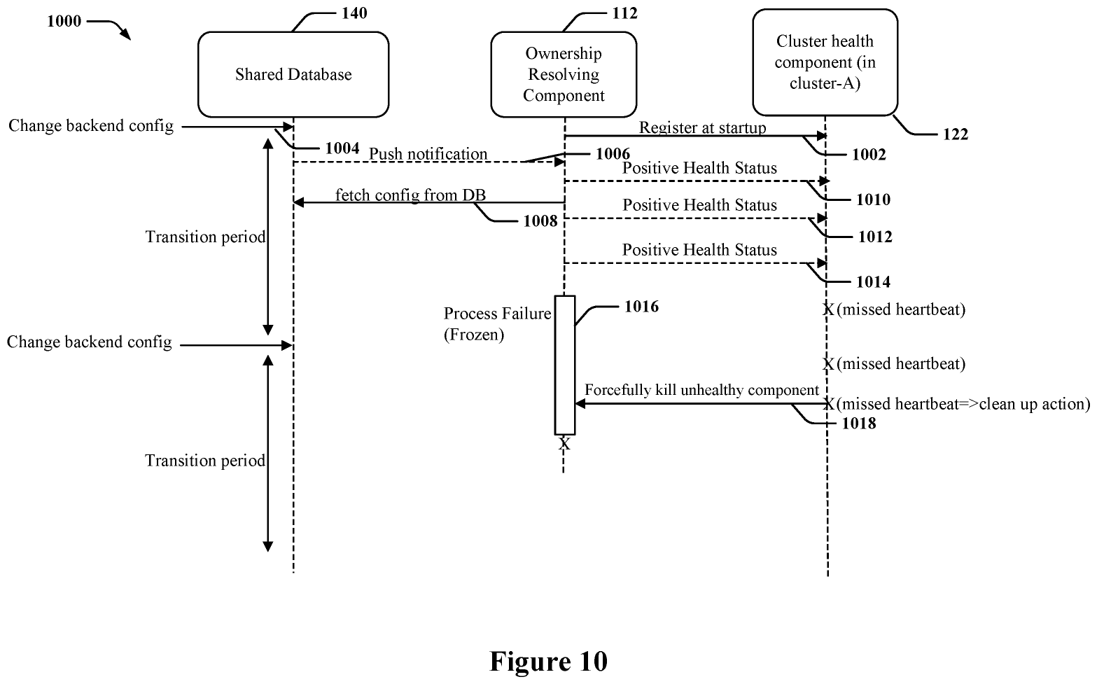

FIG. 10 illustrates an example of a call flow 1000 among various components for killing a process based on reporting unhealthy status, in accordance with aspects described herein. In call flow 1000, at 1002, an ownership resolving component 112 can register (e.g., at startup) with a cluster health component 122. A 1004, the shared database 140 can receive a command to change a backend configuration. For example, a cluster modifying component 132 of a cluster administrator 130 can change the backend cluster configuration in the shared database 140 based on modifying a collection of clusters (e.g., such to add, remove, or modify the clusters, a workload the clusters can handle, etc.). In an example, ownership resolving component 112 can optionally receive a push notification change from the shared database at 1006, and/or at 1008, can attempt to fetch the current cluster configuration from the shared database 140. Ownership resolving component 112 can periodically transmit health information indicating positive health status at 1010, 1012, and 1014. A process at the ownership resolving component 112 can fail or freeze at 1016, resulting in multiple missed positive health status indications (e.g., heartbeats). After a certain number of missed heartbeats at the cluster health component 122 (e.g., 3 in the depicted example), cluster health component 122 can forcefully kill the unhealthy component (e.g., the ownership resolving component 112) at 1018, which can halt the stateful workload and/or cause another cluster to pick up the stateful workload.

In accordance with aspects described above, a shared database (or storage solution) to store the cluster configuration can be provided. A processing cycle and a transition period can be defined as durations agreed upon across clusters. The clusters use the same or similar threshold on retries before declaring outages. The clusters and the database can use a timing protocol to synchronize their clocks. Both the current and previous cluster configurations can be maintained in the shared database. More than 1 configuration change per transition period may not be allowed, and the constraint may be enforced by the shared database. Ownership resolvers can only serve requests when their cache is up to date, e.g., at most one processing cycle behind the database. Otherwise, the ownership can be deemed unknown. The ownership resolver and the job handlers can register with the cluster health manager and periodically report their status-failure to do so may cause them to be shut down and restarted. The ownership resolver response can be a function of the current cluster configuration, the previous cluster configuration, the timing of the last impactful change, the ability to update its cache.

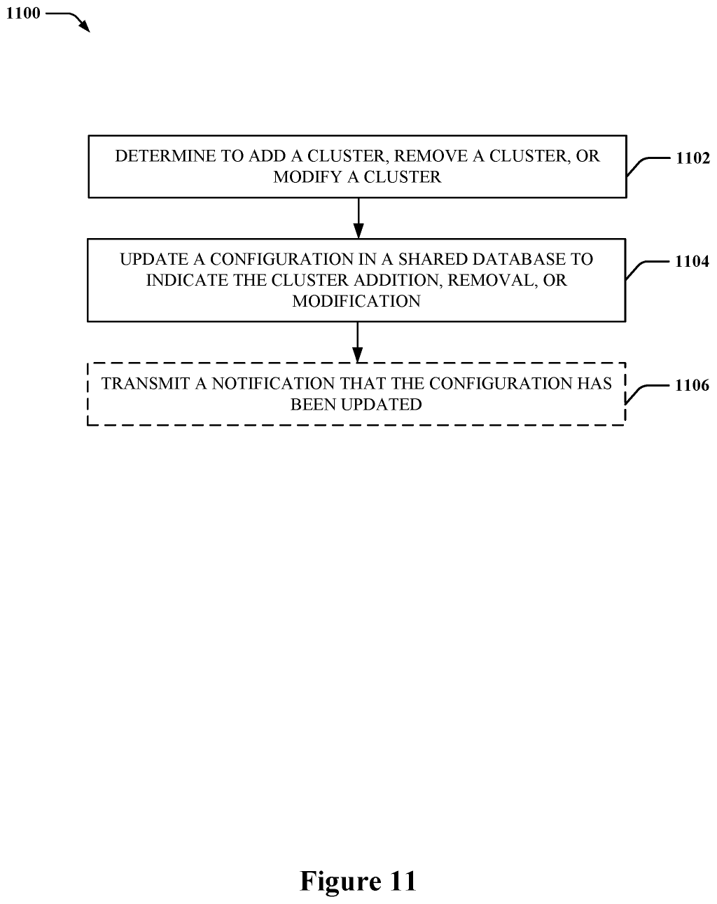

FIG. 11 is a flowchart of an example of a method 1100 for modifying a set of clusters, in accordance with aspects described herein. For example, method 1100 can be performed by a cluster administrator 130, which may be a device, as described, having one or more processors and/or memory/memories and/or an operating system for performing corresponding functionality.

In method 1100, at action 1102, it can be determined to add a cluster, remove a cluster, or modify a cluster. In an example, cluster modifying component 132, e.g., in conjunction with processor(s) 102, memory/memories 104, operating system 106, etc. of a cluster administrator 130, can determine to add the cluster, remove the cluster, or modify the cluster. For example, cluster modifying component 132 can determine to add a cluster based on detecting additional provisioned network resources (e.g., additional physical machines, such as servers, additional VMs, or other network nodes that can provide job handler functions). In an example, cluster modifying component 132 can determine to remove a cluster based on removal of network resources. In an example, cluster modifying component 132 can determine to modify one or more clusters to shift load balancing among the clusters based on various considerations. In any case, modification of a set of clusters can result in updating a cluster configuration.

In method 1100, at action 1104, a configuration in a shared database can be updated to indicate the cluster addition, removal, or modification. In an example, cluster modifying component 132, e.g., in conjunction with processor(s) 102, memory/memories 104, operating system 106, etc. of a cluster administrator 130, can update the configuration in the shared database 140, e.g., by creating a new current cluster configuration 208, to indicate the cluster addition, removal, or modification. In an example, the cluster configuration can be updated to add information of any newly added clusters, remove information of any removed clusters, or modify parameters of existing clusters, as described above. In this regard, various ownership resolving components 112 of various clusters can obtain the current cluster configuration 208 stored in the shared database 140.

In method 1100, optionally at action 1106, a notification that the configuration has been updated can be transmitted. In an example, cluster modifying component 132, e.g., in conjunction with processor(s) 102, memory/memories 104, operating system 106, etc. of a cluster administrator 130, or the shared database 140, can transmit the notification (e.g., to one or more ownership resolving components 112) that the configuration has been updated. As described, this can cause one or more ownership resolving components 112 to request the updated cluster configuration 208 from the shared database 140. In addition, as described, the shared database 140 can enforce a constraint to only allow one update to the cluster configuration 208 per transition period, so the one or more ownership resolving components 112 can ensure they are able to retrieve and use an accurate cluster configuration per transition period.

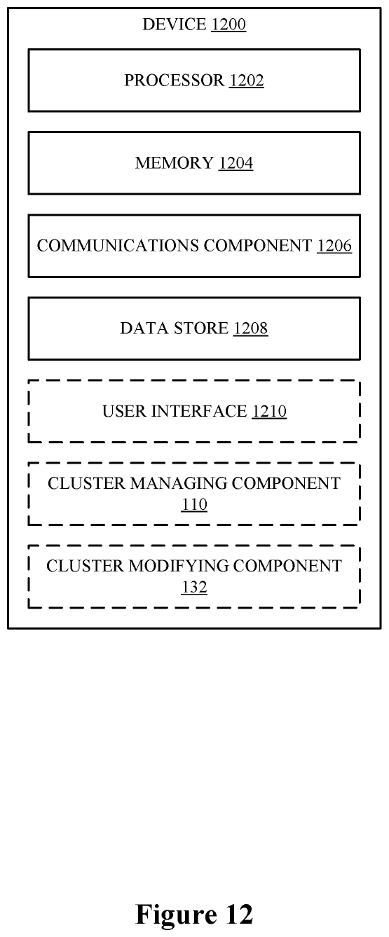

FIG. 12 illustrates an example of device 1200 including additional optional component details as those shown in FIG. 1. In one aspect, device 1200 may include processor 1202, which may be similar to processor(s) 102 for carrying out processing functions associated with one or more of components and functions described herein. Processor 1202 can include a single or multiple set of processors or multi-core processors. Moreover, processor 1202 can be implemented as an integrated processing system and/or a distributed processing system.

Device 1200 may further include memory 1204, which may be similar to memory/memories 104 such as for storing local versions of operating systems (or components thereof) and/or applications being executed by processor 1202, such as a cluster managing component 110, cluster modifying component 132, one or more subcomponents thereof, etc. Memory 1204 can include a type of memory usable by a computer, such as random access memory (RAM), read only memory (ROM), tapes, magnetic discs, optical discs, volatile memory, non-volatile memory, and any combination thereof.

Further, device 1200 may include a communications component 1206 that provides for establishing and maintaining communications with one or more other devices, parties, entities, etc. utilizing hardware, software, and services as described herein. Communications component 1206 may carry communications between components on device 1200, as well as between device 1200 and external devices, such as devices located across a communications network and/or devices serially or locally connected to device 1200. For example, communications component 1206 may include one or more buses, and may further include transmit chain components and receive chain components associated with a wireless or wired transmitter and receiver, respectively, operable for interfacing with external devices.

Additionally, device 1200 may include a data store 1208, which can be any suitable combination of hardware and/or software, that provides for mass storage of information, databases, and programs employed in connection with aspects described herein. For example, data store 1208 may be or may include a data repository for operating systems (or components thereof), applications, related parameters, etc.) not currently being executed by processor 1202. In addition, data store 1208 may be a data repository for cluster managing component 110, cluster modifying component 132, one or more subcomponents thereof, and/or one or more other components of the device 1200.

Device 1200 may optionally include a user interface component 1210 operable to receive inputs from a user of device 1200 and further operable to generate outputs for presentation to the user. User interface component 1210 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 1210 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for distributing stateful workloads to clusters, comprising:
obtaining, for a cluster, a previous configuration from a shared database, wherein the previous configuration includes a previous indication of a previous owner of a stateful workload;
obtaining, for the cluster and from the shared database, a configuration including an indication of a current owner of the stateful workload;
based on determining that the cluster is the current owner:
determining, based on the indication of the current owner, whether the cluster is the previous owner of the stateful workload;
based on determining that the cluster is the previous owner of the stateful workload, continuing processing a next state of the stateful workload; and
based on determining that the cluster is not the previous owner of the stateful workload, waiting for a duration before processing the next state of the stateful workload; and
based on determining that the cluster is not the current owner, refraining from processing the stateful workload.

2. The computer-implemented method of claim 1, wherein determining that the cluster is the current owner is based on consistent hashing using an attribute of the cluster indicated in the configuration and a property of a workspace of the stateful workload.

3. The computer-implemented method of claim 1, further comprising determining the duration based on whether the previous owner of the stateful workload acknowledged the configuration or not.

4. The computer-implemented method of claim 1, wherein obtaining the configuration is performed based on a request from a job handler in the cluster for an indication of the current owner of the stateful workload.

5. The computer-implemented method of claim 4, wherein determining the cluster is the current owner is based on whether a cache of the configuration process is up to date.

6. The computer-implemented method of claim 1, further comprising periodically reporting health status to a cluster health manager.

7. The computer-implemented method of claim 6, wherein periodically reporting the health status includes declaring an unhealthy status based on failure to obtain the configuration from the shared database.

8. The computer-implemented method of claim 6, further comprising killing a process of the stateful workload based on receiving an indication from the cluster health manager, wherein the indication is based on the cluster health manager not receiving the reported health status.

9. The computer-implemented method of claim 1, wherein the shared database allows one update of the current owner per a transition period defined for changing ownership for stateful workloads.

10. The computer-implemented method of claim 1, wherein obtaining the configuration is based on receiving, from the shared database or a cluster administrator, a notification indication that the configuration has been updated.

11. A device for distributing stateful workloads to a cluster, comprising:
one or more memories storing instructions; and
one or more processors coupled to the one or more memories and configured to execute the instructions to:
store, in the one or more memories, a previous configuration received from a shared database, wherein the previous configuration includes a previous indication of a previous owner of a stateful workload;
obtain, for the cluster and from the shared database, a configuration including an indication of a current owner of the stateful workload;
based on determining that the cluster is the current owner and the previous owner, provide a response to a job handler to process a next state of the stateful workload;
based on determining that the cluster is the current owner and not the previous owner, provide a response to a job handler to wait a duration and then process a next state of the stateful workload; and
based on determining that the cluster is the not current owner, refrain from processing the stateful workload.

12. The device of claim 11, wherein the one or more processors are configured to execute the instructions to determine that the cluster is the current owner based on consistent hashing using an attribute of the cluster indicated in the configuration and a property of a workspace of the stateful workload.

13. The device of claim 11, wherein the one or more processors are configured to execute the instructions to determine the duration based on whether the previous owner of the stateful workload acknowledged the configuration or not.

14. The device of claim 11, wherein the one or more processors are configured to execute the instructions to obtain the configuration based on a request from a job handler in the cluster for an indication of the current owner of the stateful workload.

15. The device of claim 14, wherein the one or more processors are configured to execute the instructions to determine that the cluster is the current owner based on whether a cache of the configuration is up to date.

16. The device of claim 11, wherein the one or more processors are configured to execute the instructions to periodically report health status to a cluster health manager.

17. The device of claim 11, wherein the shared database allows one update of the current owner per a transition period defined for changing ownership for stateful workloads.

18. The device of claim 11, wherein the one or more processors are configured to execute the instructions to obtain the configuration based on receiving, from the shared database or a cluster administrator, a notification indication that the configuration has been updated.

19. A non-transitory computer-readable medium storing instructions thereon that, when executed by at least one computing device, cause the at least one computing device to perform operations for distributing stateful workloads to clusters, comprising:
obtaining a previous configuration from a shared database, wherein the previous configuration includes a previous indication of a previous owner of a stateful workload;
obtaining, for a cluster and from the shared database, a configuration including an indication of a current owner of the stateful workload;
based on determining that the cluster is the current owner and the previous owner, providing a response to a job handler to process a next state of the stateful workload;
based on determining that the cluster is the current owner and not the previous owner, providing a response to a job handler to wait a duration and then process a next state of the stateful workload; and
based on determining that the cluster is the not current owner, refraining from processing the stateful workload.

20. The non-transitory computer-readable medium of claim 19, further comprising determining that the cluster is the current owner based on consistent hashing using an attribute of the cluster indicated in the configuration and a property of a workspace of the stateful workload.
